(19) United States
(12) Patent Application Publication
(10) Pub. No.: US 2025/0165107 A1
(43) Pub. Date: May 22, 2025

(54) INPUT DEVICE

(71) Applicant: Panasonic Automotive Systems Co., Ltd., Kanagawa (JP)

(72) Inventors: Shinji KANDA, Osaka (JP); Sho SONODA, Osaka (JP); Kento WAKIDA, Osaka (JP); Yuma KITAGAWA, Osaka (JP); Aoi ITO, Aichi (JP)

(21) Appl. No.: 18/937,865

(22) Filed: Nov. 5, 2024

(30) Foreign Application Priority Data
Nov. 16, 2023 (JP) 2023-195020

(51) Int. Cl. G06F 3/044

(52) U.S. Cl. CPC G06F 3/0446; G06F 3/0443

(57) ABSTRACT

An input device includes a sensor for detecting a position of a detection target on an operation surface. The sensor includes a substrate including an operation area that is quadrilateral in shape and a plurality of electrodes arranged in the operation area of the substrate in a matrix. The plurality of electrodes comprise a plurality of sensing electrode columns each of which includes two or more of the plurality of electrodes arranged to be conductive in a Y direction and a plurality of sensing electrode rows each of which includes two or more of the plurality of electrodes arranged to be conductive in an X direction that intersects the Y direction. The Y direction is approximately parallel to a first edge of the operation area. The X direction is approximately parallel to a second edge of the operation area which intersects the first edge.

### CROSS REFERENCE TO RELATED APPLICATION

The present application is based on and claims priority of Japanese Patent Application No. 2023-195020 filed on Nov. 16, 2023.

### FIELD

The present disclosure relates to an input device.

### BACKGROUND

Patent Literature (PTL) 1 discloses an input device that includes an operation surface with which a detection target that performs an input operation comes into contact and a sensor unit that detects a position at which the detection target is in contact with the operation surface.

### CITATION LIST

### Patent Literature

PTL 1: Japanese Patent No. 5581904

### SUMMARY

However, the input device disclosed by the above-described PTL 1 can be improved upon.

In view of this, the present disclosure provides an input device capable of improving upon the above related art.

In order to provide such an input device, an input device according to one aspect of the present disclosure is an input device that receives an operation input from a detection target to an operation surface. The input device includes a sensor for detecting a position of the detection target on the operation surface. The sensor includes a substrate including an operation area that is quadrilateral in shape and a plurality of electrodes arranged in the operation area of the substrate in a matrix. The plurality of electrodes comprise a plurality of sensing electrode columns each of which includes two or more of the plurality of electrodes arranged to be conductive in a Y direction and a plurality of sensing electrode rows each of which includes two or more of the plurality of electrodes arranged to be conductive in an X direction that intersects the Y direction. The Y direction is approximately parallel to a first edge of the operation area. The X direction is approximately parallel to a second edge of the operation area which intersects the first edge.

An input device according to the present disclosure can inhibit a reduction in sensitivity.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram illustrating an input device provided in a vehicle.

FIG. 2 is a block diagram illustrating the input device according to the embodiment.

FIG. 3 is a plan view of an input cover and a sensor included in the input device according to the embodiment.

FIG. 4 is a cross sectional view of the input cover and the sensor taken along line IV-IV shown in FIG. 3.

FIG. 5 is a plan view of a first layer and a second layer.

FIG. 6 is a flowchart showing an operation example of operations performed by the input device.

FIG. 7 is an image diagram illustrating the sensor after correction by rotation has been performed.

FIG. 8 is a plan view of a sensor according to a comparative example.

FIG. 9 is a cross sectional view of the sensor according to the comparative example, taken along line IX-IX shown in FIG. 8.

### DESCRIPTION OF EMBODIMENT

The embodiments described below each show a general or specific example. The numerical values, shapes, materials, elements, the arrangement and connection of the elements, steps, orders of the steps, etc., presented in the embodiment below are mere examples, and are not intended to limit the present disclosure. In addition, among the elements in the embodiments below, those not recited in any one of the independent claims will be described as optional elements. Moreover, the embodiments may be combined.

Furthermore, the drawings are schematic diagrams, and do not necessarily provide strictly accurate illustrations. Throughout the drawings, the same reference sign is given to the same element.

In the following embodiments, expressions such as approximately parallel to, quadrilateral in shape or quadrilateral-shaped, parallel to an X direction, and parallel to a Y direction are used. For example, the expression approximately parallel to not only means that an element is exactly parallel to another element, but also means that the element is substantially parallel to the other element. The expression quadrilateral in shape or quadrilateral-shaped not only means that the shape is perfectly quadrilateral, but also means that the shape is substantially quadrilateral. The expression parallel to the X direction not only means that an element is exactly parallel to the X direction, but also means that the element is substantially parallel to the X direction. The expression parallel to the Y direction not only means that an element is exactly parallel to the Y direction, but also means that the element is substantially parallel to the Y direction. In other words, the meanings of these expressions each contain an error of approximately several percent. In addition, the expressions approximately parallel to, quadrilateral in shape or quadrilateral-shaped, parallel to the X direction, and parallel to the Y direction respectively mean parallel, quadrilateral, parallel to the X direction, and parallel to the Y direction to an extent that the advantageous effects of the present disclosure can be achieved. The same applies to other expressions using “approximately”, “shape” or “-shaped”, and “direction”.

For an input device to be hereinafter described, an X direction, a Y direction that intersects the X direction, an X′ direction, and a Y′ direction that intersects the X′ direction are specified.

Hereinafter, embodiments will be described in detail with reference to the drawings.

### EMBODIMENT

### [Configuration]

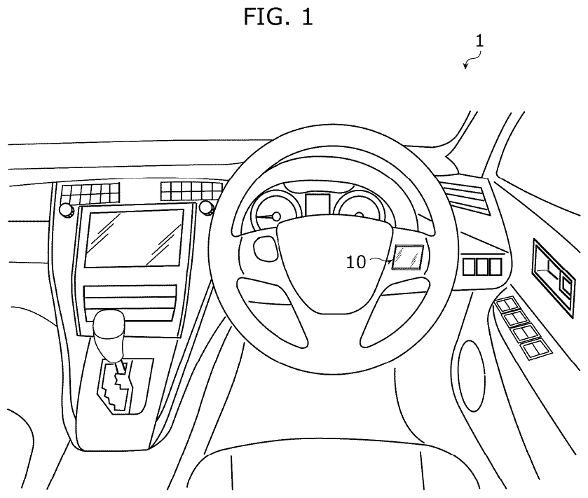

First, a configuration of input device 10 will be described with reference to FIG. 1 through FIG. 5.

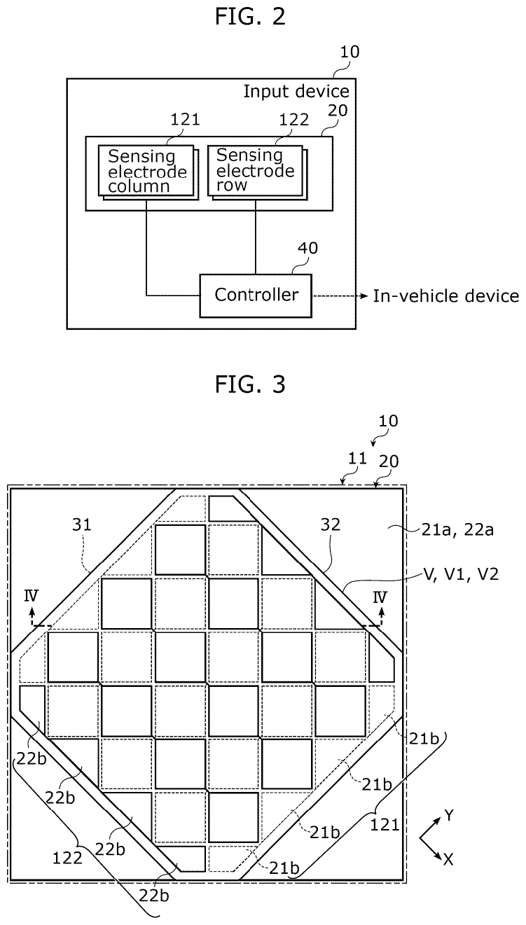

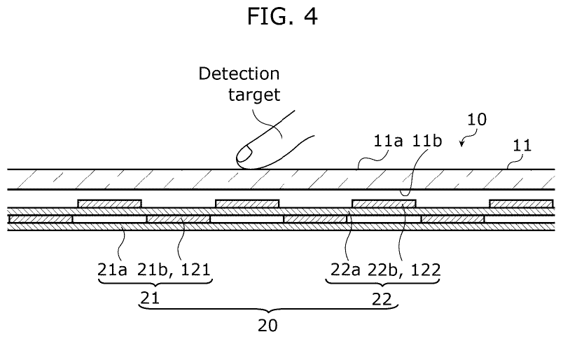

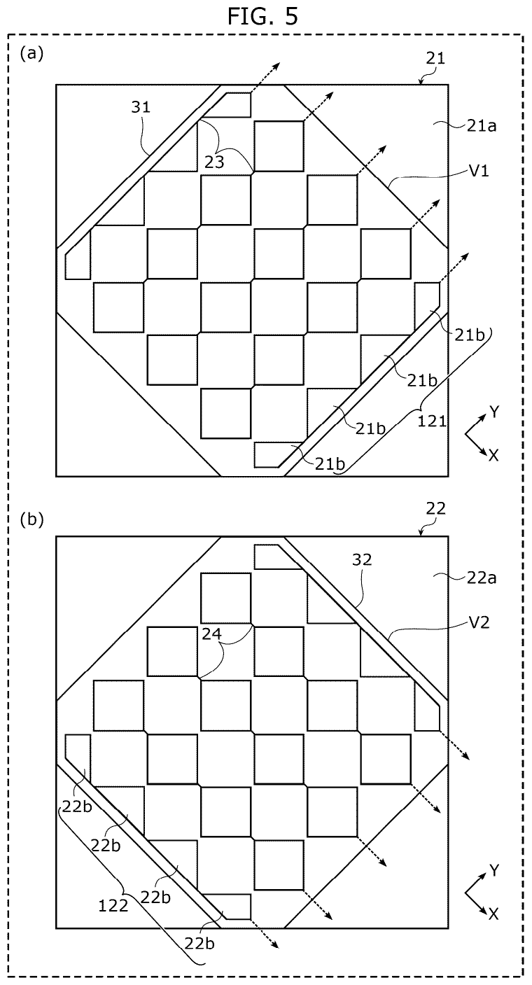

FIG. 1 is a schematic diagram illustrating input device 10 provided in vehicle 1. FIG. 2 is a block diagram illustrating input device 10 according to the embodiment. In FIG. 2, a signal to be output to an in-vehicle device is denoted by a dashed line. FIG. 3 is a plan view illustrating input cover 11 and sensor 20 which are included in input device 10 according to the embodiment. FIG. 4 is a cross sectional view of input cover 11 and sensor 20 taken along line IV-IV shown in FIG. 3. FIG. 5 is a plan view of first layer 21 and second layer 22. Part (a) of FIG. 5 shows first layer 21. Part (b) of FIG. 5 shows second layer 22. In part (a) and part (b) of FIG. 5, signals to be output from a plurality of sensing electrode columns 121 and a plurality of sensing electrode rows 122 to controller 40 are denoted by dashed lines.

As illustrated in FIG. 1, input device 10 is arranged in, with its operation surface exposed, a spoke that is connected with the steering shaft of vehicle 1, the center console, doors, the instrument panel, the roof, etc. With this, input device 10 can receive an operation input from a user to the operation surface. FIG. 1 shows an example in which input device 10 is arranged in the spoke that is connected with the steering shaft of vehicle 1. Note that input device 10 need not be limited to, for example, the present embodiment, and may be arranged in another location in the passenger cabin.

In response to receiving an operation input from a user using a detection target, input device 10 outputs, to an in-vehicle device, a signal based on the operation input to control the in-vehicle device. With this, the in-vehicle device operates in accordance with the operation input. As described above, a user can operate an in-vehicle device provided in vehicle 1 by performing an operation input on input device 10 using a detection target. The detection target is a pointing device, such as a user's finger and a stylus.

The in-vehicle device is, for example, a car navigation system including a display device, etc., audio equipment for reproducing an optical disk, an in-vehicle air-conditioning device, an in-vehicle lighting device, or a video reproduction device.

Next, a specific configuration of input device 10 will be described.

As illustrated in FIG. 2 through FIG. 4, input device 10 includes input cover 11, sensor 20, and controller 40.

Input cover 11 is exposed outside input device 10 such that input cover 11 can receive an operation input by a detection target. Input cover 11 is arranged facing sensor 20 and is spaced apart from sensor 20 with a spacer interposed therebetween. Input cover 11 covers sensor 20. Input cover 11 is arranged in an orientation approximately parallel to sensor 20. The spacer may be integrated with input cover 11, may be integrated with sensor 20, or may be another element that can separate input cover 11 and sensor 20.

Input cover 11 is made of, for example, glass or an acrylic board. In the present embodiment, input cover 11 is quadrilateral in shape in plan view. FIG. 3 shows an example in which input cover 11 is square in shape in a plan view of input cover 11. The shape of input cover 11 in the plan view of input cover 11 is not limited to a quadrilateral, and may be other polygons other than a quadrilateral. In the present embodiment, a quadrilateral shape includes at least a square shape and a rhomboid shape.

Input cover 11 includes operation surface 11a and opposing surface 11b.

Operation surface 11a is an exterior surface of input cover 11 which directly receives an operation input from a detection target. Operation surface 11a is arranged so as to be in an orientation approximately parallel to an XY-plane formed by the X direction and the Y direction. Opposing surface 11b is an undersurface that is on the opposite side of input cover 11 relative to operation surface 11a of input cover 11. Opposing surface 11b is arranged facing sensor 20.

Sensor 20 is in an orientation approximately parallel to the XY-plane, and is arranged so as to face opposing surface 11b of input cover 11.

Sensor 20 includes a plurality of electrodes 21b and a plurality of electrodes 22b arranged in a matrix. Specifically, the plurality of electrodes 21b and 22b are laid out in a matrix such that quadrilateral-shaped operation area V of sensor 20 is filled with the plurality of electrodes 21b and 22b. For this reason, operation area V and the entire outline of the plurality of electrodes 21b and 22b arranged in a matrix are in the same quadrilateral shape. Note that the plurality of electrodes 21b and 22b do not cover the entirety of operation area V. The plurality of electrodes 21b and 22b are arranged at fixed intervals. In the present embodiment, operation area V is rhomboid in shape in plan view. To be more specific, operation area V is in the shape of a rhomboid without four corners. Moreover, operation area V is to be substantially quadrilateral in shape, and may be in the shape of a polygon other than a quadrilateral in a strict sense. In other words, the expression the same not only includes the case where things are perfectly the same, but also includes the case where the things are substantially the same.

The plurality of electrodes 21b and 22b arranged in a matrix allow sensor 20 to output, to controller 40, a signal for detecting a position of a detection target that performs an operation input to operation surface 11a. For example, sensor 20 is a capacitive touchpad. In response to an operation input performed on operation surface 11a by a user using a detection target, sensor 20 outputs, to controller 40, a signal for detecting a position of the detection target that has come into contact with operation surface 11a.

Specifically, sensor 20 includes first layer 21 in which the plurality of sensing electrode columns 121 for detecting a position of the detection target in the Y direction are arranged and second layer 22 in which the plurality of sensing electrode rows 122 for detecting a position of the detection target in the X direction are arranged. In sensor 20, first layer 21 and second layer 22 overlap. Accordingly, sensor 20 has a stacked structure including first layer 21 and second layer 22. Here, the Y direction is a direction in which two or more electrodes 21b included in sensing electrode column 121 are aligned in a plan view of sensor 20. The X direction is a direction in which two or more electrodes 22b included in sensing electrode row 122 are aligned in the plan view of sensor 20. For this reason, the Y direction is a direction that intersects the X direction in the plan view of sensor 20. In the present embodiment, the Y direction is approximately orthogonal to the X direction in the plan view of sensor 20. Note that the plurality of electrodes 21b and the plurality of electrodes 22b are also generic names for two or more electrodes 21b included in sensing electrode column 121 and two or more electrodes 22b included in sensing electrode row 122, respectively.

As illustrated in part (a) of FIG. 5, first layer 21 includes first substrate 21a and the plurality of sensing electrode columns 121.

First substrate 21a is a flat board that is approximately parallel to sensor 20, and is arranged above or below second layer 22. In the present embodiment, first substrate 21a is arranged below second layer 22. For first substrate 21a, a printed circuit board, a rigid substrate, a flexible substrate, a ceramic substrate, or a resin substrate including a resin material as a base is used, for example. First substrate 21a is included in a substrate.

On a surface of first substrate 21a, first operation area V1 that is provided for arranging the plurality of sensing electrode columns 121 is formed. In plan view, first operation area V1 is quadrilateral in shape. In the present embodiment, first operation area V1 is rhomboid in shape in plan view. First operation area V1 has two first edges 31 that are approximately parallel to the Y direction and are arranged in the X direction. First edge 31 corresponds to one side of first operation area V1 that is quadrilateral in shape. Note that first operation area V1 is to be substantially quadrilateral in shape, and may be in the shape of a polygon other than a quadrilateral in a strict sense. First operation area V1 is included in operation area V.

Since the plurality of sensing electrode columns 121 are arranged in first operation area V1 of first substrate 21a, first substrate 21a is provided with pattern wiring for outputting, to controller 40, a signal based on a detected operation input.

Each sensing electrode column 121 includes two or more electrodes 21b that are arranged to be conductive in the Y direction. In plan view, each of the two or more electrodes 21b included in each sensing electrode column 121 is quadrilateral in shape. In each sensing electrode column 121, quadrilateral-shaped electrodes 21b each have approximately equal diagonal lines and two or more electrodes 21b are aligned to be conductive in the Y direction. Part (a) of FIG. 5 shows an example of sensing electrode columns 121 each of which includes four electrodes 21b aligned in the Y direction and conductive via line 23.

The two or more electrodes 21b included in sensing electrode columns 121 also include electrodes in the shape of a polygon other than a quadrilateral. Electrodes 21b in the shape of a polygon other than a quadrilateral are arranged along first edge 31 of first operation area V1 where quadrilateral-shaped electrode 21b cannot be arranged in first operation area V1. Supposing that electrodes 21b in the shape of a polygon other than a quadrilateral are also in the shape of a quadrilateral, these electrodes 21b each have approximately equal diagonal lines and two or more of these electrodes 21b are aligned to be conductive in the Y direction.

As illustrated in part (b) of FIG. 5, second layer 22 includes second substrate 22a and the plurality of sensing electrode rows 122.

Second substrate 22a is a flat board that is approximately parallel to sensor 20, and is arranged above or below first layer 21. In the present embodiment, second substrate 22a is arranged above first layer 21, and is arranged so as to face input cover 11 and to be in an orientation approximately parallel to input cover 11. For second substrate 22a, a printed circuit board, a rigid substrate, a flexible substrate, a ceramic substrate, or a resin substrate including a resin material as a base is used, for example. Second substrate 22a is included in the substrate.

On a surface of second substrate 22a, second operation area V2 that is provided for arranging the plurality of sensing electrode rows 122 is formed. In plan view, second operation area V2 is quadrilateral in shape. In the present embodiment, second operation area V2 is rhomboid in shape in plan view. Second operation area V2 has two second edges 32 that are approximately parallel to the X direction and are arranged in the Y direction. Second edge 32 corresponds to one side of second operation area V2 that is quadrilateral in shape. Second operation area V2 and first operation area V1 are in the same shape. Note that second operation area V2 is to be substantially quadrilateral in shape, and may be in the shape of a polygon other than a quadrilateral in a strict sense. Second operation area V2 is included in operation area V. Note that first operation area V1 and second operation area V2 may be collectively called operation area V in the present embodiment.

Since the plurality of sensing electrode rows 122 are arranged in second operation area V2 of second substrate 22a, second substrate 22a is provided with pattern wiring for outputting, to controller 40, a signal based on a detected operation input.

Each sensing electrode row 122 includes two or more electrodes 22b that are arranged to be conductive in the X direction. In plan view, each of two or more electrodes 22b included in each sensing electrode row 122 is quadrilateral in shape. In each sensing electrode row 122, quadrilateral-shaped electrodes 22b each have approximately equal diagonal lines and two or more electrodes 22b are aligned in the X direction. Part (b) of FIG. 5 shows an example of sensing electrode rows 122 each of which includes four electrodes 22b aligned in the X direction and conductive via line 24.

The two or more electrodes 22b included in sensing electrode rows 122 also include electrodes in the shape of a polygon other than a quadrilateral. Electrodes 22b in the shape of a polygon other than a quadrilateral are arranged along second edge 32 of second operation area V2 where quadrilateral-shaped electrode 22b cannot be arranged in second operation area V2. Supposing that electrodes 22b in the shape of a polygon other than a quadrilateral are also in the shape of a quadrilateral, these electrodes 22b each have approximately equal diagonal lines, and two or more of these electrodes 22b are aligned to be conductive in the X direction.

As illustrated in FIG. 3 and FIG. 4, sensor 20 has a stacked structure including first layer 21 and second layer 22. Accordingly, in a plan view of sensor 20, first operation area V1 of first substrate 21a and second operation area V2 of second substrate 22a overlap such that first operation area V1 and second operation area V2 approximately coincide. In addition, since the plurality of electrodes 21b and the plurality of electrodes 22b are arranged in a matrix in the plan view of sensor 20, the plurality of sensing electrode columns 121 and the plurality of sensing electrode rows 122 do not overlap. In the plan view of sensor 20, two or more electrodes 21b included in sensing electrode columns 121 and two or more electrodes 22b included in sensing electrode rows 122 are arranged in a grid-like pattern in operation area V of sensor 20.

In the present embodiment, the plurality of sensing electrode columns 121 each include an equivalent number of electrodes 21b. The plurality of sensing electrode rows 122 each also include an equivalent number of electrodes 22b. For this reason, the plurality of sensing electrode columns 121 have approximately uniform detection area sizes, and the plurality of sensing electrode rows 122 also have approximately uniform detection area sizes. Note that, in the present embodiment, the term equivalent not only applies to the case where things are exactly identical, but may also applies to the case where things are substantially identical. The case where things are substantially identical is the case where there is a difference of about a few number of items from an average number of items is present. Here, a detection area size of first operation area V1 means the total sum of the surface area sizes of the plurality of sensing electrode columns 121, and a detection area size of second operation area V2 means the total sum of the surface area sizes of the plurality of sensing electrode rows 122.

The number of electrodes 21b included in each sensing electrode column 121 is equivalent to the number of electrodes 22b included in each sensing electrode row 122. For this reason, the plurality of sensing electrode columns 121 and the plurality of sensing electrode rows 122 have approximately uniform detection area sizes.

Controller 40 includes, for example, a static integrated circuit (IC) that is electrically connected with each of the plurality of sensing electrode columns 121 and the plurality of sensing electrode rows 122. Since each sensing electrode column 121 is conductive in the Y direction and each sensing electrode row 122 is conductive in the X direction, controller 40 detects a position on operation surface 11a on which an operation input has been performed by a detection target, based on a signal based on the operation input detected by sensor 20. For example, when a detection target is placed on operation surface 11a, a capacitance between an n-th sensing electrode column 121 among the plurality of sensing electrode columns 121 and the detection target changes, and an m-th sensing electrode row 122 among the plurality of sensing electrode rows 122 and the detection target changes. Based on a signal based on the operation input detected by the n-th sensing electrode column 121 and a signal based on the operation input detected by the m-th sensing electrode row 122, controller 40 detects a position on operation surface 11a at which the n-th sensing electrode column 121 and the m-th sensing electrode row 122 intersect. Note that n and m are natural numbers greater than or equal to 1.

The lengthwise direction (Y direction) of the plurality of sensing electrode columns 121 and the lengthwise direction (X direction) of the plurality of sensing electrode rows 122 are tilted relative to a Y′ direction and an X′ direction of an X′-Y′ coordinate system. Note that the Y′ direction is the forward-backward direction or the up-down direction, and the X′ direction is the left-right direction. In the present embodiment, the Y′ direction is approximately orthogonal to the X′ direction.

For this reason, controller 40 corrects an X-Y coordinate system formed by the Y direction and the X direction to the X′-Y′ coordinate system by rotating the X-Y coordinate system based on an angle of the Y direction relative to the Y′ direction of the X′-Y′ coordinate system and an angle of the X direction relative to the X′ direction of the X′-Y′ coordinate system. Controller 40 outputs a result obtained by correcting the X-Y coordinate system to the X′-Y′ coordinate system by rotation. In other words, since controller 40 can detect a position in the X-Y coordinate system which has been corrected to a position in the X′-Y′ coordinate system by rotation, controller 40 outputs a signal based on the position in the X′-Y′ coordinate system to an in-vehicle device.

### Operation Example

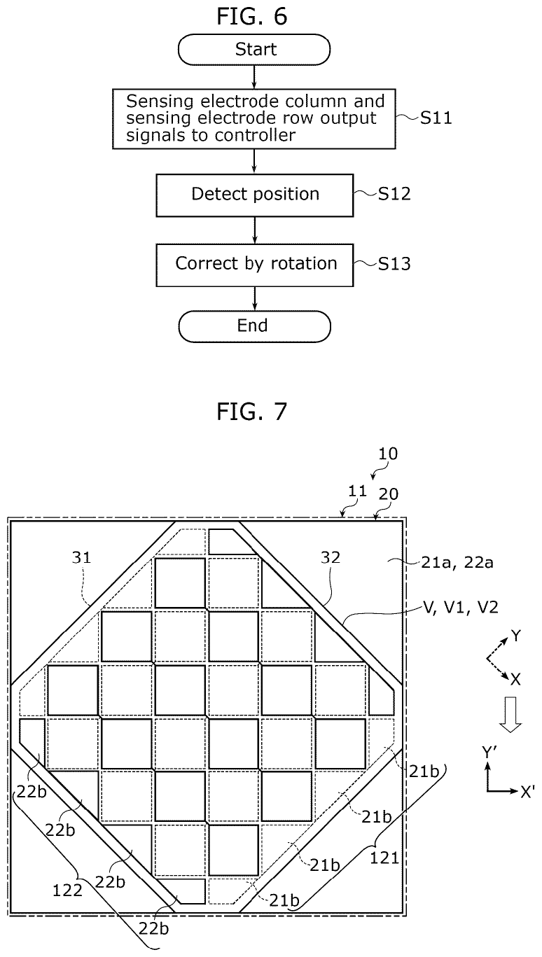

Next, an operation example of operations performed by input device 10 will be described with reference to FIG. 6 and FIG. 7.

FIG. 6 is a flowchart showing an operation example of operations performed by input device 10. FIG. 7 is an image diagram illustrating sensor 20 after correction by rotation has been performed. FIG. 7 shows the X-Y coordinate system before correction by rotation is performed and the X′-Y′ coordinate system obtained after the correction by rotation has been performed.

First, in response to an operation input performed on operation surface 11a by a user using a detection target, sensing electrode column 121 and sensing electrode row 122 both of which correspond to a position at which the operation input has been performed output signals to controller 40 (S11).

Next, when controller 40 receives the signals from sensing electrode column 121 and sensing electrode row 122, controller 40 detects, based on the signals, the position indicated in an X-Y coordinate system that is formed by a Y direction and an X direction (S12).

Next, controller 40 corrects the X-Y coordinate system to an X′-Y′ coordinate system by rotating the X-Y coordinate system based on an angle of the Y direction relative to a Y′ direction of the X′-Y′ coordinate system and an angle of the X direction relative to an X′ direction of the X′-Y′ coordinate system. Specifically, controller 40 rotates the X-Y coordinate system by only angle θ such that the X-Y coordinate system coincides with the X′-Y′ coordinate system, to correct a position indicated in the X-Y coordinate system (shown below as [Math. 1]) to a position indicated in the X′-Y′ coordinate system (shown below as [Math. 2]) (S13).

$$\begin{matrix}[ Math . 1 ] & \\ ( \begin{matrix}X \\ Y\end{matrix} ) & \end{matrix}$$

$$\begin{matrix}[ Math . 2 ] & \\ ( \begin{matrix}{X}^{′} \\ {Y}^{′}\end{matrix} ) & \end{matrix}$$

For example, controller 40 uses Equation (1) (see [Math. 3] shown below) to correct the X-Y coordinate system to the X′-Y′ coordinate system by rotation.

$$\begin{matrix}[ Math . 3 ] & \\ ( \begin{matrix}{X}^{′} \\ {Y}^{′}\end{matrix} ) = ( \begin{matrix}cos θ & - sin θ \\ sin θ & cos θ\end{matrix} ) ( \begin{matrix}X \\ Y\end{matrix} ) & Equation ( 1 )\end{matrix}$$

With this, controller 40 can correct, as illustrated in FIG. 7, the position indicated in the X-Y coordinate system to the position indicated in the X′-Y′ coordinate system by rotation. In other words, the position in the X-Y coordinate system at which the detection target has been detected is corrected to the position in the X′-Y′ coordinate system by rotation.

Controller 40 outputs the position in the X′-Y′ coordinate system which is a result obtained by correcting the X-Y coordinate system to the X′-Y′ coordinate system by rotation.

### Advantageous Effects

Next, advantageous effects produced by input device 10 according to the present embodiment will be described.

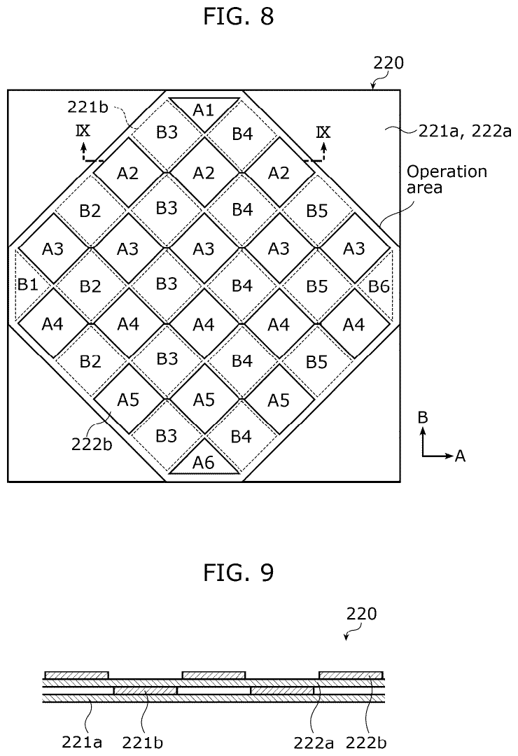

For example, FIG. 8 and FIG. 9 are shown as a comparative example. FIG. 8 is a plan view of sensor 220 according to the comparative example. FIG. 9 is a cross sectional view of sensor 220 according to the comparative example, taken along line IX-IX shown in FIG. 8

As illustrated in FIG. 8 and FIG. 9, sensor 220 according to the comparative example includes substrate 221a, quadrilateral-shaped electrodes B1, B2, B3, B4, B5, and B6 which are arranged on a surface of substrate 221a, substrate 222a, and quadrilateral-shaped electrodes A1, A2, A3, A4, A5, and A6 which are arranged on a surface of substrate 222a. Substrate 222a and electrodes A1, A2, A3, A4, A5, and A6 are stacked above substrate 221a and electrodes B1, B2, B3, B4, B5, and B6.

In a plan view of sensor 220, electrodes B1, B2, B3, B4, B5, and B6 and electrodes A1, A2, A3, A4, A5, and A6 are arranged in a matrix.

Each of quadrilateral-shaped electrodes B2, B3, B4, and B5 has approximately equal diagonal lines. Each of sets of electrodes B2, electrodes B3, electrodes B4, and electrodes B5 is aligned to be conductive in a B direction. Electrode B1 and electrode B6 are triangle in shape and are arranged at respective two corners in an A direction of an operation area that is quadrilateral in shape. Note that the B direction is the forward-backward direction or the up-down direction, and the A direction is the left-right direction.

Each of quadrilateral-shaped electrodes A2, A3, A4, and A5 has approximately equal diagonal lines. Each of sets of electrodes A2, electrodes A3, electrodes A4, and electrodes A5 is aligned to be conductive in the A direction. Electrode A1 and electrode A6 are triangle in shape and are arranged at respective two corners in the B direction of an operation area that is quadrilateral in shape.

Since each of sets of electrodes B2, electrodes B3, electrodes B4, and electrodes B5 is conductive in the B direction and each of sets of electrodes A2, electrodes A3, electrodes A4, and electrodes A5 is conductive in the A direction, a position of a detection target on sensor 220 can be detected.

In the above-described sensor 220, there is a difference in detection area size between (i) triangle-shaped electrode B1 and triangle-shaped electrode B6, (ii) three electrodes B2 and three electrodes B5, and (iii) five electrodes B3 and five electrodes B4. There is also a difference in detection area size between (i) triangle-shaped electrode A1 and triangle-shaped A6, (ii) three electrodes A2 and three electrodes A5, and (iii) five electrodes A3 and five electrodes A4. For this reason, detection sensitivity at a location, such as a corner or an edge of the quadrilateral-shaped operation areas, is low when a detection target approaches sensor 220. Accordingly, a position of the detection target cannot be accurately detected depending on a location of sensor 220 at which the detection target approaches.

For example, the above-described PTL 1 discloses a capacitive detection touchpad that outputs an X and Y coordinates, and includes first sensor electrode groups arranged in an X direction in an X-Y coordinate system and second sensor electrode groups arranged in a Y direction in the X-Y coordinate system. However, in PTL 1, when electrodes are arranged up to edges of a substrate in which the first sensor electrode groups and the second sensor electrode groups are arranged, sensor area sizes of electrodes arranged at corners of the substrate are small. This results in a reduction in sensitivity to detect an operation surface with which a detection target comes into contact.

In view of the above, input device 10 presented in technical aspect 1 of the present embodiment is, as has been described above, input device 10 that receives an operation input from a detection target to operation surface 11a, and includes sensor 20 for detecting a position of the detection target on operation surface 11a. Moreover, sensor 20 includes a substrate including an operation area that is quadrilateral in shape and a plurality of electrodes 21b and 22b arranged in the operation area of the substrate in a matrix. In addition, the plurality of electrodes 21b and 22b comprise a plurality of sensing electrode columns 121 each of which includes two or more of the plurality of electrodes 21b arranged to be conductive in a Y direction and a plurality of sensing electrode rows 122 each of which includes two or more of the plurality of electrodes 22b arranged to be conductive in an X direction that intersects the Y direction. The Y direction is approximately parallel to first edge 31 of the operation area. The X direction is approximately parallel to second edge 32 of the operation area which intersects first edge 31.

According to the above, sensing electrode columns 121 are arranged parallel to first edge 31 of a quadrilateral-shaped operation area, and sensing electrode rows 122 are arranged parallel to second edge 32 of the quadrilateral-shaped operation area. Accordingly, it is not likely that a detection area size is found small depending on a detected position, as compared to the comparative example. In sensing electrode columns 121 and sensing electrode rows 122 according to the present disclosure, detection area sizes of sensing electrode columns 121 and sensing electrode rows 122 arranged at the corners and edges of the operation area are large compared to the comparative example. Accordingly, it is expected that a position of a detection target on operation surface 11a will be accurately detected wherever the detection target is located on operation surface 11a.

Therefore, input device 10 according to the present disclosure can inhibit a reduction in sensitivity.

In addition, input device 10 presented in technical aspect 2 of the present embodiment is input device 10 according to technical aspect 1. In this case, input device 10 further includes controller 40 that corrects an X-Y coordinate system formed by the Y direction and the X direction to an X′-Y′ coordinate system by rotating the X-Y coordinate system based on an angle of the Y direction relative a Y′ direction of the X′-Y′ coordinate system and an angle of the X direction relative to an X′ direction of the X′-Y′ coordinate system.

According to the above, the position of a detection target present on operation surface 11a in the X-Y coordinate system can be corrected to the position in the X′-Y′ coordinate system by rotation. Accordingly, it is expected that the position of the detection target will be accurately detected.

Moreover, input device 10 presented in technical aspect 3 of the present embodiment is input device 10 according to technical aspect 1 or 2. In this case, the plurality of sensing electrode columns 121 each include an equivalent number of the plurality of electrodes 21b. Moreover, the plurality of sensing electrode rows 122 each also include an equivalent number of the plurality of electrodes 22b.

According to the above, each of the plurality of sensing electrode columns 121 has sensitivity equivalent to the sensitivity of each of the plurality of sensing electrode rows 122. Accordingly, it is expected that a detection target present on operation area 11a will be even more accurately detected.

In addition, input device 10 presented in technical aspect 4 of the present embodiment is input device 10 according to any one of technical aspects 1 to 3. In this case, the total number of the plurality of electrodes 21b included in each of the plurality of sensing electrode columns 121 is equivalent to the total number of the plurality of electrodes 22b included in each of the plurality of sensing electrode rows 122.

According to the above, sensing electrode columns 121 and sensing electrode rows 122 have equivalent sensitivity. Accordingly, it is expected that a detection target present on operation area 11a will be even more accurately detected.

Moreover, input device 10 presented in technical aspect 5 of the present embodiment is input device 10 according to any one of technical aspects 1 to 4. In this case, the shape of operation area V is the same as the entire outline shape of the plurality of electrodes 21b and 22b arranged in a matrix.

According to the above, a plurality of electrodes 21b and 22b can be laid out to coincide with the shape of operation area V.

Accordingly, it is expected that a position of a detection target will be accurately detected even though the detection target is present at an edge or a corner of operation surface 11a.

### Other Variations, etc.

Hereinbefore, the present disclosure has been described based on the embodiments, but the present disclosure is not limited to the above-described embodiments.

For example, in input device 10 according to the above-described embodiments, sensor 20 may only include a single substrate. In this case, the plurality of sensing electrode columns 121 may be arranged on one surface of the substrate, and the plurality of sensing electrode rows 122 may be arranged on the other surface, namely the back surface the substrate.

In addition, controller 40, etc., included in input device 10 according to the above-described embodiments are typically implemented as large scale integration (LSI) circuits that are integrated circuits. These elements may be individually implemented as a single chip, or some or all of the elements may be implemented as a single chip.

Circuit integration is not limited to LSI; each element may be implemented as a dedicated circuit or generic processor. A field programmable gate array (FPGA) that is programmable after manufacturing of the LSI circuit, or a reconfigurable processor whose circuit cell connections and settings in the LSI circuit are reconfigurable, may be used.

It should be noted that each element in the above-described embodiments may be configured as a dedicated hardware product or may be implemented by executing a software program suitable for the element. Each element may be implemented as a result of a program execution unit, such as a CPU or processor or the like, loading and executing a software program stored in a storage medium such as a hard disk or semiconductor memory.

Moreover, figures used above are all examples presented to specifically describe the present disclosure, and the embodiments of the present disclosure are not limited to the used figures presented as examples.

The block diagrams illustrate examples of the division of functional blocks. Accordingly, a plurality of functional blocks may be implemented as a single functional block, a single functional block may be broken up into a plurality of functional blocks, and some of functions may be transferred to another functional block. Moreover, the functions of a plurality of function blocks having similar functions may be processed by a single hardware product or a single software program in parallel or by time-division.

Those skilled in the art will readily appreciate that various modifications may be made in these embodiments and that other embodiments may be obtained by optionally combining the elements and functions of the embodiments without materially departing from the novel teachings and advantages of the present disclosure.

Accordingly, all such modifications and other embodiments are included in the present disclosure.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2023-195020 filed on Nov. 16, 2023.

### INDUSTRIAL APPLICABILITY

The present disclosure is applicable to input devices to be provided in vehicles, for example.

1. An input device that receives an operation input from a detection target to an operation surface, the input device comprising:
a sensor for detecting a position of the detection target on the operation surface, wherein
the sensor includes a substrate including an operation area that is quadrilateral in shape and a plurality of electrodes arranged in the operation area of the substrate in a matrix,
the plurality of electrodes comprise a plurality of sensing electrode columns each of which includes two or more of the plurality of electrodes arranged to be conductive in a Y direction and a plurality of sensing electrode rows each of which includes two or more of the plurality of electrodes arranged to be conductive in an X direction that intersects the Y direction,
the Y direction is approximately parallel to a first edge of the operation area, and
the X direction is approximately parallel to a second edge of the operation area which intersects the first edge.

2. The input device according to claim 1, further comprising:
a controller that corrects an X-Y coordinate system formed by the Y direction and the X direction to an X′-Y′ coordinate system by rotating the X-Y coordinate system based on an angle of the Y direction relative a Y′ direction of the X′-Y′ coordinate system and an angle of the X direction relative to an X′ direction of the X′-Y′ coordinate system.

3. The input device according to claim 1, wherein
the plurality of sensing electrode columns each include an equivalent number of the plurality of electrodes, and
the plurality of sensing electrode rows each also include an equivalent number of the plurality of electrodes.

4. The input device according to claim 1, wherein
a total number of the plurality of electrodes included in each of the plurality of sensing electrode columns is equivalent to a total number of the plurality of electrodes included in each of the plurality of sensing electrode rows.

5. The input device according to claim 1, wherein
a shape of the operation area is same as an entire outline shape of the plurality of electrodes arranged in a matrix.

6. The input device according to claim 2, wherein
the plurality of sensing electrode columns each include an equivalent number of the plurality of electrodes, and
the plurality of sensing electrode rows each also include an equivalent number of the plurality of electrodes.

7. The input device according to claim 2, wherein
a total number of the plurality of electrodes included in each of the plurality of sensing electrode columns is equivalent to a total number of the plurality of electrodes included in each of the plurality of sensing electrode rows.

8. The input device according to claim 2, wherein
a shape of the operation area is same as an entire outline shape of the plurality of electrodes arranged in a matrix.
